(19) United States
(12) Patent Application Publication
(10) Pub. No.: US 2024/0280542 A1
(43) Pub. Date: Aug. 22, 2024

(54) PIPE MATERIAL DETECTION USING ACOUSTICAL WAVE PROPAGATION

(71) Applicant: Mueller International, LLC, Atlanta, GA (US)

(72) Inventors: Joseph Butterfield, North East Lincolnshire (GB); Valentin Mircea Burtea, Toronto (CA); Bruce Robertson, Toronto (CA); Sebastien Perrier, Peterborough (CA)

(21) Appl. No.: 18/113,028

(22) Filed: Feb. 22, 2023

(51) Int. Cl. G01N 29/07; G01N 29/11; G01N 29/28

(52) U.S. Cl. CPC G01N 29/07; G01N 29/11; G01N 29/28

(57) ABSTRACT

Methods, systems, and computer-readable storage media for determining the material of pipe in a non-invasive manner. Two acoustic sensors are attached near either end of a pipe segment. An acoustical wave is generated in the pipe by exciting the pipe system at an out-of-bracket location while signal data from the first and second acoustic sensors is recorded. A speed of sound in the pipe segment and/or an attenuation factor for the pipe segment are computed from the signal data, and a material of the pipe is determined based on the computed speed of sound in the pipe segment and a relationship between speeds of sound in pipes and the materials of the pipes and/or the computed attenuation factor for the pipe segment and a relationship between attenuation factors of pipes and the materials of the pipes.

### BRIEF SUMMARY

The present disclosure relates to technologies for determining the material of a pipe in a non-invasive manner. According to some embodiments, a method comprises placing a first acoustic sensor near a first end of a pipe segment and a second acoustic sensor near an opposite end of the pipe segment, the first and second acoustic sensors in acoustical communication with the pipe. At least one acoustical wave is generated in the pipe using an excitation source at an out-of-bracket excitation location while signal data from the first and second acoustic sensors is recorded. A speed of sound in the pipe segment and/or an attenuation factor for the pipe segment are computed from the signal data, and a material of the pipe is determined based on the computed speed of sound in the pipe segment and a relationship between speeds of sound in pipes and the materials of the pipes and/or the computed attenuation factor for the pipe segment and a relationship between attenuation factors of pipes and the materials of the pipes.

According to further embodiments, a water distribution system comprises a service line, a first acoustic sensor and a second acoustic sensor in acoustical communication with the service line, and an acoustic analysis module executing on a pipe assessment system communicatively coupled to the first and second acoustic sensors. The service line connects, either directly or through intervening connections, a water main of the water distribution system to a building served by the water distribution system. The first and second acoustic sensors bracket a segment of the service line and are configured to sense acoustical waves propagating through the service line and produce signal data representing the sensed acoustical waves. The acoustic analysis module configured to record signal data from the first and second acoustic sensors during generation of an acoustical wave in the service line at an out-of-bracket excitation location. The module estimates an attenuation of the acoustical wave as it propagated along the service line from the first acoustic sensor to the second acoustic sensor and compute an attenuation factor from the estimated attenuation. The acoustic analysis module then determines whether the service line consists of lead based upon the attenuation factor for the service line and a relationship between attenuation factors of various service lines and the materials of the various service lines.

According to further embodiments, a computer-readable medium comprises processor-executable instructions that cause a processor of a pipe assessment system to record signal data from a first acoustic sensor and a second acoustic sensor during generation of an acoustical wave in a pipe at an out-of-bracket excitation location, the first and second acoustic sensors in acoustical communication with the pipe and bracketing a segment of the pipe and the signal data representing measurements of vibrations at the first and second acoustic sensors caused by the at least one acoustical wave propagating through the pipe. A speed of sound in the pipe segment and/or an attenuation factor for the pipe segment is computed based on the recorded signal data, and it is determined whether the pipe consists of lead based on the speed of sound in the pipe segment and a relationship between speeds of sound in pipes and the materials of the pipes and/or the attenuation factor for the pipe segment and a relationship between attenuation factors of pipes and the materials of the pipes.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a block diagram showing an illustrative environment in which technologies for determining the material of a pipe in a non-invasive manner may be implemented, according to embodiments presented herein.

FIGS. 2A and 2B are a flow diagram showing one routine for determining the material of a pipe in a non-invasive manner, specifically the presence of lead in a service line, according to embodiments presented herein.

FIG. 3 is a signal graph showing characteristics of signals from a pulsed excitation recorded at two acoustic sensors attached to a pipe, according to embodiments presented herein.

FIG. 4 is a signal graph showing a result of an auto-correlation function of signals from acoustic sensors to determine a time delay between the signals, according to embodiments presented herein.

FIG. 5 shows spectrum graphs of signals from the two acoustic sensors for distinct types of pipe materials, according to embodiments presented herein.

FIG. 6 shows is a graph showing an acoustic transfer function applied to the signals from the two acoustic sensors for distinct types of pipe material, according to embodiments presented herein.

FIG. 7 is a bar chart showing an octave band representation of the spectrum for signals measured at the far sensor for distinct types of pipe material, according to embodiments presented herein.

### DETAILED DESCRIPTION

The following detailed description is directed to technologies for determining the material of pipes in a non-invasive manner. Water utility companies can spend considerable sums each year on filters, chemicals, and aeration to purify the surface waters and ground waters and rid tap water of harmful contaminants. However, municipal water systems can only guarantee the purity of water up to the service connection. It is important that service lines (also referred to as “supply pipes”) from the supply pipeline (i.e., water main) to the end user are composed of materials that protect the integrity of the water. A key step in the elimination of lead, one of the most harmful pollutants, from tap water is identification and replacement of service lines consisting of lead material.

According to embodiments described herein, a low-cost and non-invasive method for determining the material of pipes may be implemented that, among other uses, may be utilized for determining whether a service line consists of lead material. The method consists of apparatus and signal processing for the characterization of in-situ pipe material using acoustical wave propagation. Specific measurements include the attenuation of sound and the speed of sound within the pipe, used to provide quantitative data for evaluating the pipe material.

According to some embodiments, two acoustic sensors, such as accelerometers or hydrophones, are connected to a service line, a first sensor connected to a stop tap or other appurtenance near a point of the connection of the service line to the water main, and a second sensor connected to a valve or other fitting near the entry of the service line into the residence, commercial building, or facility serviced by the service line, such that at least a segment of the service line is “bracketed” between the two sensors. An out-of-bracket excitation is performed on a nearby appurtenance producing acoustical waves (“sound”) in the pipe, with the sound reaching the first sensor before the second sensor. Acoustic signals are recorded at the two sensors simultaneously, and signal processing is applied to the recorded signals to determine the pipe material.

For example, a power spectral density, also known as a spectrum or auto-spectrum, may be computed for each of the two recorded acoustic signals. A transfer function is then computed as a ratio of the two power spectral densities. The transfer function may be analyzed in specific frequency bands to compute the signal attenuation in such bands, which is related to the pipe material based on known relationship between attenuation and material at specific frequencies. Similarly, a time delay may be determined between the arrival of the sound from the excitation at each of the two sensors. Knowing the length of the pipe segment between the two sensors and the time delay, the speed of sound in the pipe may be estimated. The estimated speed of sound is then compared with reference speeds of sound for that specific pipe class for different materials to determine the material properties of the pipe under test.

In some embodiments, both the attenuation of sound and speed of sound may be used to determine the service line material. The speed of sound in fluid-filled pipes has a smaller range of variation compared to sound attenuation. For instance, the speed of sound for a standard copper pipe is around 20% higher than the speed in a lead pipe. However, the sound attenuation in a lead pipe is about 4× higher than the sound attenuation in a copper pipe. Thus, in one embodiment, a greater emphasis may be placed on the determination of the pipe material from the measurement of the attenuation. In further embodiments, either the attenuation or the speed of sound may be used to determine the pipe material.

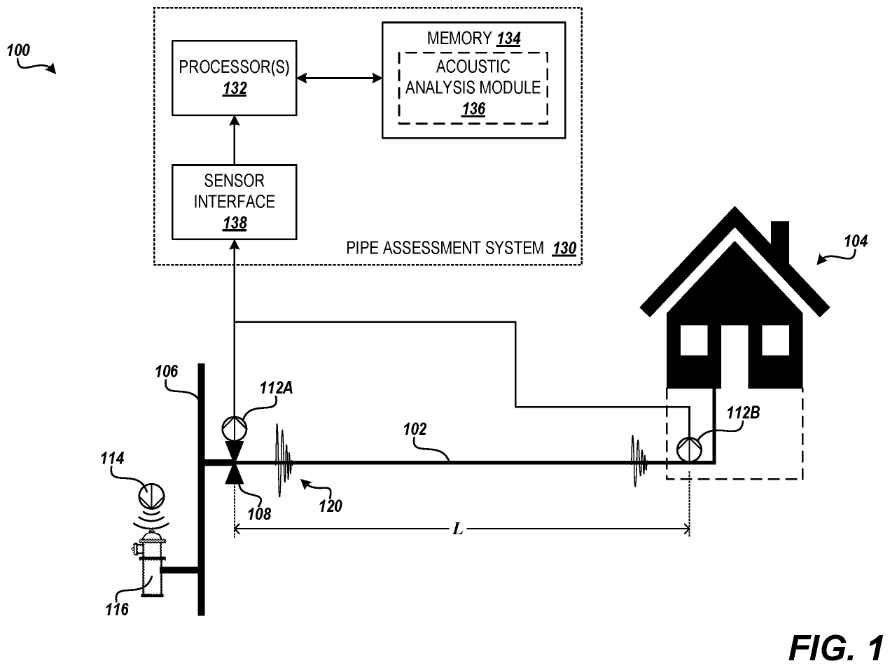

FIG. 1 and the following description are intended to provide a general description of suitable environments in which the embodiments described herein may be implemented. In particular, FIG. 1 shows an environment 100 for determining the material of a pipe in a non-invasive manner, specifically the material of a service line, according to embodiments described herein. The environment 100 includes a service line 102 connecting a residence, commercial building, or other facility serviced by the service line (referred to herein generally as “building 104”) to a fluid distribution network, such as a water main 106 of a water distribution system. According to some embodiments, the fluid distribution network may be partially or wholly subterraneous. For example, the water main 106 may be subterraneous, with valves, hydrants, and other appurtenances connected to the main accessible below ground and/or located above ground. Similarly, the service line 102 may be primarily subterraneous, with the pipe exposed where it enters the building 104, e.g., in a basement or crawlspace. In further embodiments, the service line 102 may be connected to the water main 106 at an external stop tap 108 or “curb stop,” with the stop tap accessible via a pit or curb stop box. Similarly, the service line 102 may be connected to the water distribution pipes of the building at a meter and/or an internal stop tap or shutoff valve.

According to embodiments, at least two vibration or acoustic sensors 112A, 112B (referred to herein generally as “acoustic sensors 112”) are placed in acoustical communication with the service line 102, with the first acoustic sensor 112A placed at a point at or near the connection of the service line to the water main 106, and the second acoustic sensor 112B placed at a point at or near the service line's entry into the building 104, as shown in FIG. 1. In some embodiments, the acoustic sensors 112 may comprise transducers or accelerometers attached directly to the outer wall of the service line 102 or to a valve, meter, stop tap, or other appurtenance along the service line. For example, the first acoustic sensor 112A may be attached to the external stop tap 108 of the service line 102 and the second acoustic sensor 112B may be attached to the opposite end of the service line, either directly to the pipe at an exposed point where it enters the building 104 or to an internal stop tap, valve, or meter terminating the service line inside the building 104. The distance L along the service line 102 of the pipe segment between the position of first acoustic sensor 112A and the second acoustic sensor 112B may then be measured.

For purposes of this disclosure, a component or device being “in acoustical communication with” a pipe, such as service line 102, represents the component being directly or indirectly coupled to the pipe in such a way that vibrations, acoustical impulses, or other variations in pressure traveling through the fluid in the pipe can be produced or sensed by the component. The sensors may measure the vibration of the pipe wall or appurtenance caused by the sound pressure waves in the fluid. In further embodiments, the acoustic sensor 112 may include hydrophones, geophones, accelerometers, or any combination of these and other sensors known in the art for measuring vibrations or acoustic signals.

In order to test the pipe material, one or more acoustical waves 120 are introduced into the service line 102 from an out-of-bracket position. For purposes of this disclosure, “out-of-bracket” refers to a position outside of the segment of the service line 102 bracketed by the acoustic sensors 112A and 112B, including at or directly adjacent to the position of the first or second acoustic sensor. For example, an accessible portion or appurtenance of the fluid distribution network, such as a hydrant 116 connected to the water main 106, may be identified that is out-of-bracket of the service line 102, and an excitation source 114 applied to the portion or appurtenance to generate the acoustical wave(s) 120 into the fluid path. According to embodiments, acoustical wave 120 may represent one or more acoustical impulses, vibrations, or pressure waves generated in the fluid path of the water main 106 and service line 102. The excitation source 114 may represent any means suitable for the creation of an acoustical excitation in the pipes, including a manually actuated device, such as manual excitation by a human using a hammer to strike the hydrant 116, pipe wall, or other exposed element of the fluid distribution network. In further embodiments, the excitation source may also represent a mechanical device, such as a motorized hammer or piston. In further embodiments, a continuous acoustic excitation source 114 with a broad frequency range (e.g., at least 100 Hz) may be utilized, such as a speaker, hydrophone, or fluid flow. According to further embodiments, the excitation source 114 is located some distance from the acoustic sensors 112 to avoid the sensor sensing multiple modes of vibration from the excitation.

Each of the acoustic sensors 112A and 112B sense the acoustical wave 120 in the service line 102 and produce a signal representing the sensed pulses. The signal data from the acoustic sensors 112A and 112B are received by a pipe assessment system 130 and are then processed and analyzed to determine the pipe material of the service line 102 using the methodologies described herein. According to embodiments, the pipe assessment system 130 extracts measurements regarding the acoustical wave 120 as it propagates longitudinally through the segment of the service line 102 from the first acoustic sensor 112A to the second acoustic sensor 112B, including timing and signal strength measurements. For example, the pipe assessment system 130 may utilize signal processing techniques described herein to determine a time delay between the arrival of the acoustical wave 120 at the first acoustic sensor 112A and the second acoustic sensor 112B. Utilizing this computed time delay and the known length L of the segment of the service line 102 bracketed by the acoustic sensors 112A and 112B, the acoustic propagation velocity (speed of sound) within the pipe may be estimated.

Similarly, the relative strength (sound level) of the acoustical wave 120 measured at the first acoustic sensor 112A and the second acoustic sensor 112B may be compared to determine the acoustic attenuation of the wave over the length L of the pipe segment. From the estimated speed of sound and attenuation, the material of the service line 102 may be determined.

Generally, the pipe assessment system 130 represents a collection of computing resources for the processing and analysis of the signal data received from the acoustic sensors 112 and the determination of pipe material. According to embodiments, the pipe assessment system 130 may comprise one or more computer devices and/or computing resources connected together utilizing any number of connection methods known in the art. For example, the pipe assessment system 130 may comprise a mobile computer device, such as a laptop or tablet, deployed in the field in proximity to the pipe 102 under test. Alternatively or additionally, the pipe assessment system 130 may comprise laptop or desktop computers; tablets, smartphones or mobile devices; server computers hosting application services, web services, database services, file storage services, and the like; and virtualized, cloud-based computing resources, such as processing resources, storage resources, and the like, that receive the signal data from the acoustic sensors 112 through one or more intermediate communication links or networks.

According to embodiments, the pipe assessment system 130 includes one or more processor(s) 132. The processor(s) 132 may comprise microprocessors, microcontrollers, cloud-based processing resources, or other processing resources capable of executing instructions and routines stored in a connected memory 134. The memory 134 may comprise a variety non-transitory computer-readable storage media for storing processor-executable instructions, data structures and other information within the pipe assessment system 130, including volatile and non-volatile, removable and non-removable storage media implemented in any method or technology, such as RAM; ROM; FLASH memory, solid-state disk (“SSD”) drives, or other solid-state memory technology; compact disc ROM (“CD-ROM”), digital versatile disk (“DVD”), or other optical storage; magnetic hard disk drives (“HDD”), hybrid solid-state and magnetic disk (“SSHD”) drives, magnetic tape, magnetic cassette, or other magnetic storage devices; and the like.

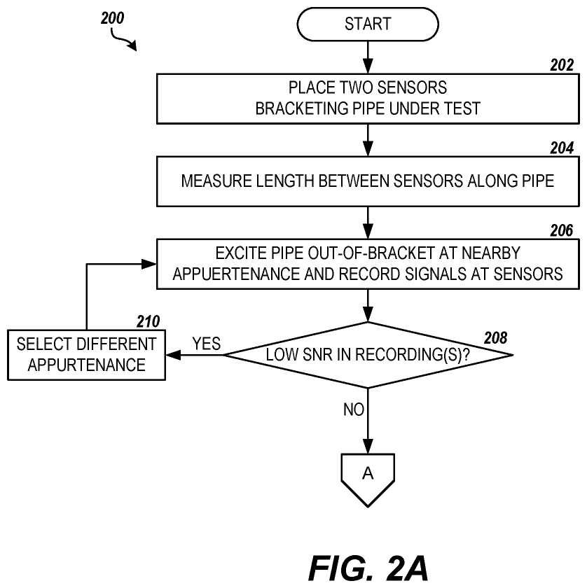

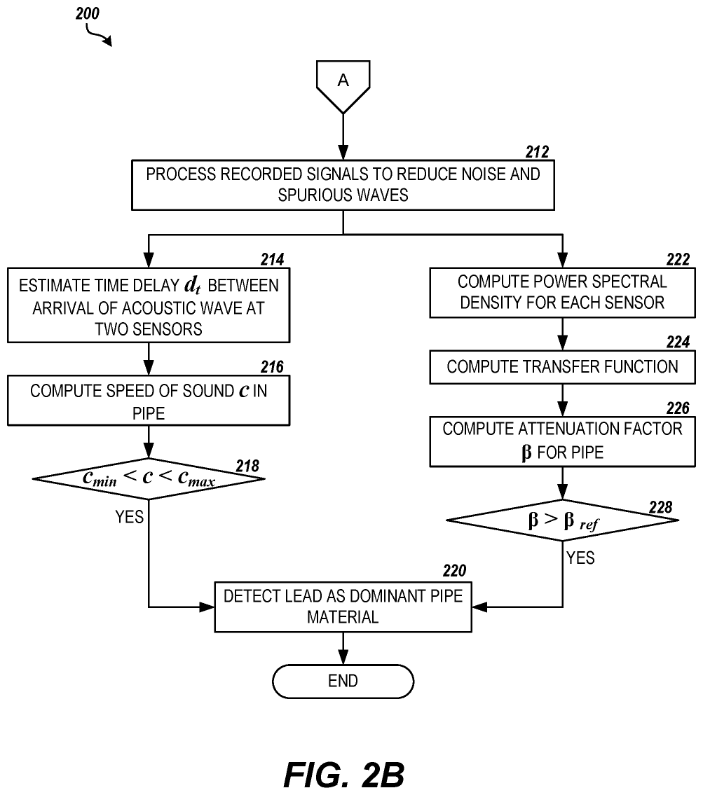

In some embodiments, the memory 134 may include an acoustic analysis module 136 for performing the acoustic analysis of the signal data from the acoustic sensors 112 to determine the material of a pipe in a non-invasive manner, as described herein. The acoustic analysis module 136 may include one or more software programs, components, and/or modules executing on the processor(s) 132 of the pipe assessment system 130. The acoustic analysis module 136 may further include hardware components specifically designed to perform one or more steps of the routines described herein. According to further embodiments, the memory 134 may store processor-executable instructions that, when executed by the processor(s) 132, perform some or all of the steps of the routine 200 described herein for determining the material of a pipe in a non-invasive manner, as described in regard to FIGS. 2A and 2B.

The pipe assessment system 130 may be in direct communication with the acoustic sensors 112 over a wired connection or may be indirectly connected to the sensors through one or more intermediate communication links and/or computing devices. For example, a laptop may be connected to the acoustic sensors 112 via one or more radio-frequency (“RF”) links, such as Bluetooth, to receive signal data from the sensors in real-time. According to some embodiments, the processor(s) 132 are operatively connected to acoustic sensors 112 through a sensor interface 138. The sensor interface 138 allows the processor(s) 132 to receive the signals from the acoustic sensors 112 representative of the sensed acoustical waves 120 in the pipe 102. For example, the sensor interface 138 may utilize one or more analog-to-digital converters (“ADCs”) to convert an analog voltage output of the acoustic sensors 112 to a digital value that is sampled by the processor(s) 132 at a specific sampling rate sufficient to represent the acoustical waves 120 in the signal data. According to some embodiments, a sampling rate around 10 kHz may be utilized to capture data representing the frequencies of interest in the pulses. In further embodiments, a sound processing unit or “sound card” of the laptop computer may be utilized to provide the sampling functionality.

In further embodiments, the memory 134 may store recordings of signal data from the acoustic sensors 112 through the sensor interface 138 taken over a period of time and/or during a number of acoustic impulses introduced by the excitation source for later analysis by the acoustic analysis module 136. In other embodiments, the signal data from the acoustic sensors 112 may be recorded by an individual computing device into its memory 134 and later sent to a central analysis computer for processing and analysis.

It will be appreciated that the structure and/or functionality of the pipe assessment system 130 may be different than that illustrated in FIG. 1 and described herein. For example, one or more of the processor(s) 132, memory 134, sensor interfaces 138, and/or other components and circuitry described may be integrated within a common integrated circuit package or distributed among multiple integrated circuit packages in one or more computing devices. In some embodiments, some or all of the processing and analysis described herein may be implemented as software applications on mobile computing platforms, such as a smartphone or laptop with cellular networking capability. Similarly, the illustrated connection pathways are provided for purposes of illustration and not of limitation, and some components and/or interconnections may be omitted for purposes of clarity. It will be further appreciated that pipe assessment system 130 may not include all of the components shown in FIG. 1, may include other components that are not explicitly shown in FIG. 1, or may utilize architectures completely different than those shown in FIG. 1.

It will be further appreciated that, while FIG. 1 shows an embodiment for determining the material of a service line 102 supplying water to a building 104, the technologies described herein may be utilized to determine the material of any number and types of pipes in a fluid distribution system in a non-invasive manner. For example, a segment of the water main 106 may be bracketed by acoustic sensors 112 and an out-of-bracket excitation introduced into main, with the recordings from the acoustic sensors analyzed to determine the pipe material of the main. The factors and relationships utilized in the analysis may be adjusted based upon the types, dimensions, and classes of pipes under test. Other scenarios in which the technologies described herein may be utilized to determine the material of a pipe a non-invasive manner will become apparent to those skilled in the art upon a reading of this disclosure, and it is intended that all such scenarios be included in the scope of this disclosure.

FIGS. 2A and 2B illustrate one routine 200 for determining the material of a pipe in a non-invasive manner, according to some embodiments. In some embodiments, parts of the routine 200 may be performed by the acoustic analysis module 136 executing on a laptop computer in direct connection with two acoustic sensors 112A and 112B associated with the pipe 102 under test, as shown in FIG. 1. In other embodiments, the routine 200 may be performed by some combination of the processor(s) 132, computing devices, components, and modules of the pipe assessment system 130 in conjunction with actions performed and parameters and data provided by maintenance personnel associated with the fluid distribution system.

The routine 200 begins at step 202, shown in FIG. 2A, where two acoustic sensors 112A and 112B are placed at either end of a segment of the pipe 102 being tested. For example, in the embodiment described above in regard to FIG. 1, the first acoustic sensor 112A is placed at a point at or near the connection of a service line 102 to the water main 106, such as attached to the curb stop or external stop tap 108 of the service line. The second acoustic sensor 112B is placed at a point at or near the service line's entry into the building, as shown in FIG. 1, such as attached directly to the pipe wall at an exposed section within the building 104 or to an internal stop tap, valve, or meter terminating the service line inside the building.

According to some embodiments, the attachment of the acoustic sensors 112 to the service line 102 or appurtenance thereof is performed in a manner that results in a temporary but fairly rigid connection between the sensor and the pipe to allow for accurate measurement of the acoustic impulses within. Ideally, the attachment of the two sensors 112 to the pipe and/or appurtenances should be identical. However, in practice, this is not always possible. Accordingly, the difference in installation of the sensors may lead to a difference in measured signal amplitude, which can impact attenuation estimates. This difference is accounted for in the processing of the signals by separating the variation of attenuation with frequency from an overall difference in signal amplitude. In some embodiments, the acoustic sensors 112 are connected directly to the pipe assessment system 130 either wirelessly or wired. In other embodiments, the acoustic sensors may be indirectly connected to the pipe assessment system through one or more intermediate computing devices connected to the pipe assessment system via a network.

Next, the routine 200 proceeds from step 202 to step 204, where the distance L along the segment of the pipe 102 between the positions of first acoustic sensor 112A and the second acoustic sensor 112B is measured. For example, the distance L may be determined by personnel onsite as accurately as possible using direct measurement, diagrams, surveys, and other methods of measurements known in the art.

From step 204, the routine 200 proceeds to step 206, where an excitation of the pipe system by an excitation source 114 is performed resulting in at least one acoustical wave 120 being introduced into the pipe 102 under test while signal data from the acoustic sensors 112A and 112B is simultaneously recorded by the pipe assessment system 130. According to embodiments, the location of the excitation is out-of-bracket of the segment of the pipe 102 bracketed by the acoustic sensors 112A and 112B. For example, as shown in FIG. 1, the excitation source 114 may comprise maintenance personnel tapping with a hammer on an above-ground appurtenance of the water main 106, such as a hydrant 116, or directly on an exposed section of the water main or service line 102 itself. In addition, the location of the hydrant 116 or exposed section of pipe where the excitation is performed at some distance from the acoustic sensors 112 to avoid the sensors sensing multiple modes of vibration from the excitation.

As described above, the excitation introduces an acoustical wave 120 into the pipe 102 that propagates longitudinally along the length L of the pipe and is observed first by the first acoustic sensor 112A and then by second acoustic sensor 112B after a certain time delay. According to embodiments, the pipe assessment system 130 may record signal data from the acoustic sensors 112 during the excitation representing the measurement of multiple acoustical waves 120 introduced into the pipe 102.

The routine 200 proceeds from step 206 to 208, where the pipe assessment system 130 analyzes the signal data recorded from acoustic sensors 112 to compute a signal-to-noise ratio (“SNR”) in the signals from the sensed acoustical wave(s) 120. In some embodiments, the SNR is computed as the ratio of the maximum value of the waveform envelope during the excitation to the maximum value of waveform envelope during a quiet period. In further embodiments, the SNR may be computed by any method known in the art. It is then determined whether the SNR in the recorded signal data is too low for analysis of the signals by the pipe assessment system 130. If is determined that the SNR in the signal data is too low for analysis, then the routine 200 proceeds to step 210, where a different out-of-bracket location, e.g., a different appurtenance or exposed section of pipe, may be selected for excitation. In some embodiments, the new out-of-bracket location may also include location(s) at the opposite end of the service line 102, e.g., inside the building 104. From step 210, the routine 200 returns to step 208, where the excitation at the new location and recording of signal data from the acoustic sensors 112 is repeated.

If, at step 208, it is determined that the SNR in the recorded signal data is sufficient for analysis, then the routine 200 proceeds to the performance of the analyses by the pipe assessment system 130 for pipe material determination, as shown in FIG. 2B. It will be appreciated that analysis of the recorded signal data by the pipe assessment system 130 may occur immediately following acquisition of the signal recordings from the acoustic sensors 112 or at any subsequent time after recording of the signal data, depending upon the needs and/or design of the system.

The analyses begin at step 212, where the pipe assessment system 130 pre-processes the signal recording(s) to remove noise and eliminate spurious waves. For example, to remove unwanted reflections and reverberations, the pipe assessment system 130 applies a mask to signal data to retain only the leading portion of the waveform(s) from the excitation. Depending on site configuration, the retention length may range from 10 ms to 100 ms depending on the length of the service line 102. In further embodiments, the signal data may be processed utilizing “coherent averaging” over multiple acoustical waves 120 (acoustic impulses) introduced in the service line 102 during excitation and captured in the recorded signal data, as described in U.S. patent application Ser. No. 16/935,945, filed Jul. 22, 2020, and entitled “ACOUSTIC PIPE CONDITION ASSESSMENT USING COHERENT AVERAGING,” which is incorporated herein in its entirety by this reference. This will produce clean waveform(s) for speed and attenuation analysis as described below while further reducing spurious signals caused by pipe joints or other repairs in the pipe 102 as well as high levels of background noise that may be present in the signals due to traffic noise and/or other surface or sub-surface noise.

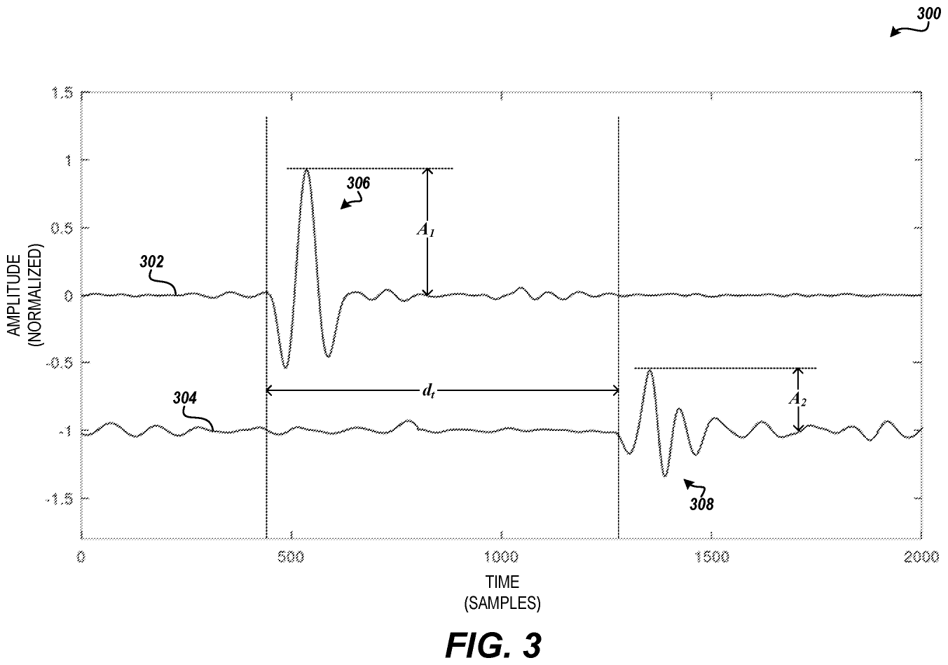

From step 212, the routine 200 proceeds along multiple paths dependent on the properties of the signals required by the pipe assessment system 130 to determine the material of the pipe 102. As described above, the pipe assessment system 130 may utilize one or both of a speed of sound estimate and an attenuation estimate from the signals recorded from the acoustic sensors 112A and 112B to determine the material of the service line 102. FIG. 3 shows a signal graph 300 that illustrates these two signal characteristics relevant to the analysis. The graph depicts a first signal 302 recorded from the first acoustic sensor 112A and a second signal 304 recorded simultaneously from the second acoustic sensor 112B over time (in samples). As may be seen in the graph 300, a time delay dₜ exists between the arrival of an acoustical wave 120 at the first acoustic sensor 112A, represented by waveform 306, and the arrival of the same acoustical wave at the second acoustic sensor 112B, represented by waveform 308. The time delay dₜ may be estimated from the recorded signals 302 and 304 and, in conjunction with the known distance/between acoustic sensors 112A and 112B, a speed of sound in the service line 102 can be determined. In addition, a difference between the maximum amplitude A₁ of waveform 306 in the first signal 302 and the maximum amplitude A₂ of waveform 308 in the second signal 304 represents the attenuation of the signal over the distance L between acoustic sensors 112A and 112B.

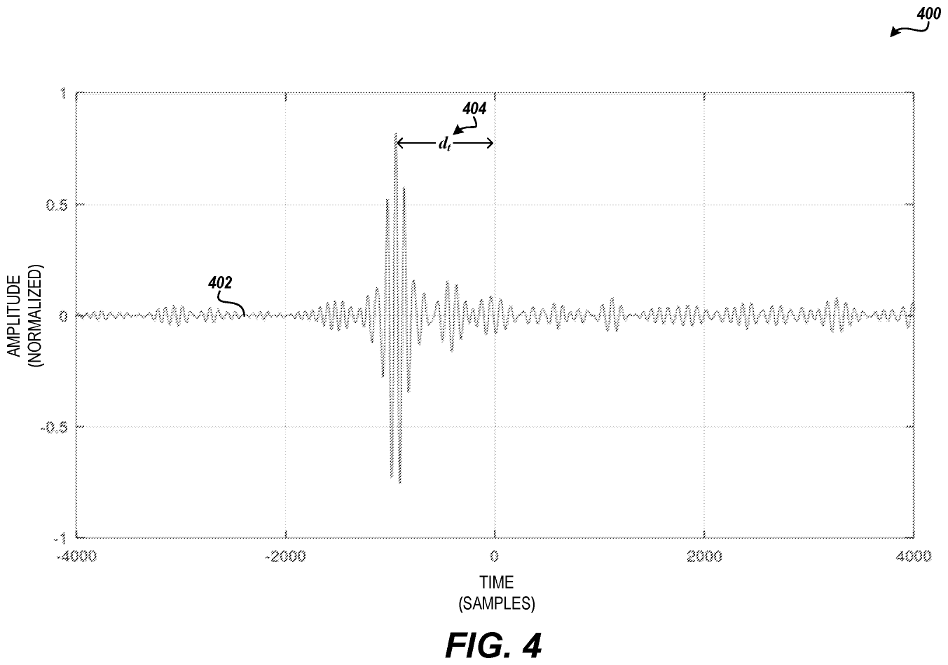

According to some embodiments, the pipe assessment system 130 may determine an estimate of the time delay dₜ using a “time-of-flight” computation, i.e., measuring the time between the arrival of an acoustical wave 120 at the first acoustic sensor 112A and the arrival of the same acoustical wave at the second acoustic sensor 112B, as shown at step 214 in FIG. 2B. However, some ambiguity may exist in the signals 302 and 304 as to exactly where the waveforms 306 and 308 representing the measured acoustical wave 120 begin. Accordingly, in further embodiments, a cross-correlation 402 between the signals 302 and 304 may alternatively or additionally be performed, with the peak value of the correlation representing a more accurate estimation of the time delay dₜ, as shown at 404 in FIG. 4. Further details regarding methodologies and techniques for accurate determination of the time delay dₜ are described in U.S. patent application Ser. No. 16/935,945 referenced above, according to further embodiments.

The routine 200 then proceeds to step 216, where the pipe assessment system 130 computes the propagation velocity of the acoustical wave 120 (speed of sound c) in the pipe 102 under test from the estimate of the time delay dr and the known length L of the segment bracketed by the acoustic sensors 112A and 112B. For example, the following formula may be utilized:

$$c = \frac{L}{{d}_{t}}$$

From step 216, the routine 200 proceeds to 218, where the computed speed of sound c in the pipe 102 under test is related to a material of the pipe. As is known in the art, the propagation velocity of an acoustical wave (speed of sound) in a pipe is related to both the fluid contained within and the elastic properties of the pipe material. The speed of sound c in a water-filled pipe is given by:

$$c = \frac{{c}_{0}}{\sqrt{1 + α \frac{K}{E} ( \frac{D}{h} + μ )}}$$

where c₀ is the speed of sound in water, K is the bulk modulus of water, E is the Young's modulus of the pipe material, D is the internal diameter of the pipe, h is the pipe wall thickness, μ is a model correction applied for thick-walled pipes, and α models the pipe support, indicating whether the pipe has expansion joints or is axially constrained.

The Young's modulus E of lead is significantly lower than other metal found in pipes, such as copper, galvanized iron, and the like, but is higher than plastics, such as PVC. Accordingly, for a given pipe diameter D and wall thickness h, a range of expected speeds of sound cₘᵢₙ thru cₘₐₓ in water-filled pipes consisting primarily or substantially of lead may be determined. According to some embodiments, the range of speeds of sound cₘᵢₙ thru cₘₐₓ in lead pipes of various diameters D and wall thicknesses h may be predetermined and stored in the memory 134 of the pipe assessment system 130. In other embodiments, the range of speeds of sound cₘᵢₙ thru cₘₐₓ to be utilized to differentiate lead service lines 102 may be determined through experimentation using variations of the method(s) described herein with service lines of standard sizes and known materials.

If, at step 218, the pipe assessment system 130 determines that the speed of sound c in the pipe 102 computed in step 216 falls in the predetermined range of speeds for its diameter D and wall thickness h, then the routine 200 proceeds to step 220, where the pipe assessment system 130 determines that the dominant material of the pipe 102 is likely lead.

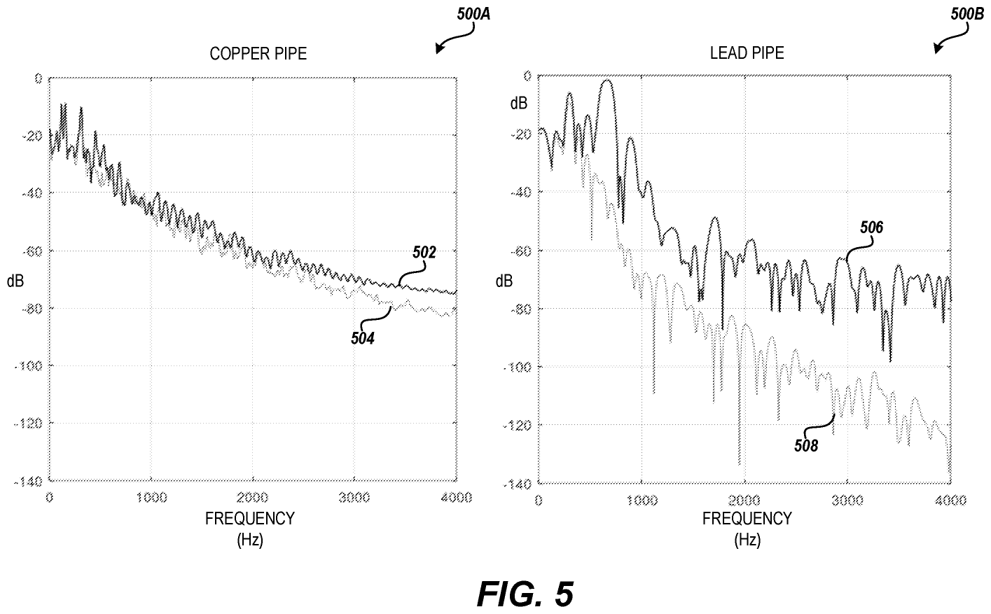

In further embodiments, the pipe assessment system 130 may measure a value for an attenuation factor β of the pipe 102 under test based on the attenuation of the acoustical wave 120 over the segment of the pipe bracketed by the acoustic sensors 112A and 112B from the recorded signals 302 and 304. According to embodiments, measurement of the attenuation factor β is preferably performed in the frequency domain and computed in a specific frequency range which is most sensitive to pipe material classification. FIG. 5 shows a first spectrum graph 500A showing spectral power plots 502 and 504 for a first acoustic sensor 112A and second acoustic sensor 112B, respectively, bracketing a segment of a fluid-filled service line 102 consisting of copper, and a second spectrum graph 500B showing spectral power plots 506 and 508 for the first and second acoustic sensors, respectively, bracketing a segment of a service line consisting primarily of lead.

As may be seen from the spectrum graphs 500A and 500B, the sound attenuation (i.e., the difference when using a logarithmic scale) between the first acoustic sensor 112A and the second acoustic sensor 112B for the lead service line 102 is more pronounced than that for the copper service line. As may further be seen in FIG. 5, the difference is most pronounced in the frequency range between 1000 Hz to 3000 Hz. In other embodiments, the frequency range could be extended down to 20 Hz to incorporate identification of additional pipe material types, such as plastic. The frequency range is determined by analyzing the spectrum of the far sensor to find the range of frequencies that include 99% of the signal power. In further embodiments, cross-spectrum or coherence could be utilized to determine the relevant frequency range.

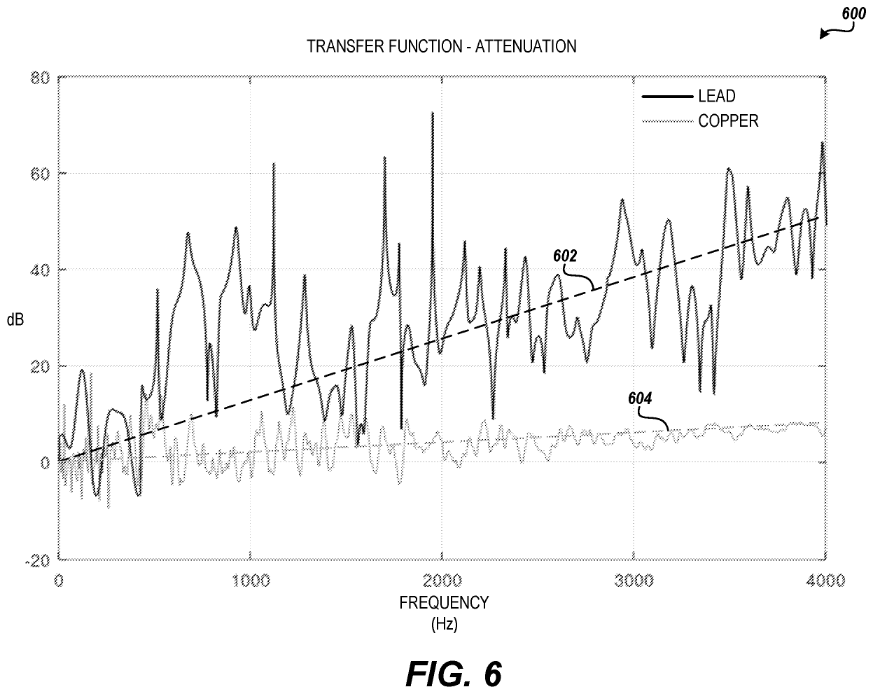

FIG. 6 shows a frequency response function, also referred to as a transfer function 600, computed between signal recordings from each of the acoustic sensors 112A and 112B in the frequency domain for an acoustical wave 120 propagating through fluid-filled lead and copper service lines 102. The transfer function represents the ratio between the spectral power of the signal from the first acoustic sensor 112A (the “close” sensor) and the spectral power of the signal from the second acoustic sensor 112B (the “far” sensor). The transfer function is an expression of the sound attenuation. As may be seen in FIG. 6, the sound level of the acoustical wave(s) 120 attenuate exponentially depending on frequency and pipe length. When using a logarithmic scale, the dependency becomes linear. The sound attenuation increases with frequency and the slope is related to the material and the pipe length. As further shown in the figure, the lead pipe shows a larger sound attenuation than the copper pipe, as shown by lines 602 and 604 respectively.

The transfer function (frequency response function H) for a pipe may be modeled by:

$$H ( ω , L ) = A {e}^{- β \frac{ω}{{c}_{0}} L}$$

where ω=2πf (f being frequency), L is the distance along the pipe between the near and far sensors, c₀ is the speed of sound in water, A is a gain value related to the specific acoustic sensors 112 being utilized and the method of their installation, and β is an attenuation factor. As discussed herein, the attenuation factor β for a particular pipe segment varies based on inter alia the material properties of the pipe.

Accordingly, at step 222 in FIG. 2B, the pipe assessment system 130 computes a power spectral density for the signal recordings from each of the acoustic sensors 112A and 112B. This may be done using Bartlett's or Welch's method of averaging periodograms or other methods known in the art. Such methods of computing the spectrum of signals involve the discrete Fourier transform (DFT). In some embodiments, a fast Fourier transform (FFT) may be used for efficient implementation. Next, the routine 200 proceeds to step 224, where the acoustic power of the signals 302 and 304 in the signal recordings from acoustic sensors 112A and 112B, respectively, is computed in the selected frequency range, and ratio values between the two computed acoustic powers are determined across the frequency range. As described above, the determined spectral power ratio values represent the transfer function between the two recorded signals.

From step 224, the routine 200 proceeds to step 226, where an estimation of the attenuation factor β of the acoustical wave 120 within the pipe 102 under test is calculated based on the spectral power ratio values. According to some embodiments, this may be accomplished by fitting the transfer function 600 (expressed logarithmically) to the computed spectral power ratio values from the signal data using a linear regression, e.g., as shown at 602 and 604 in FIG. 6, with the slope of the resulting line being proportional to the attenuation factor β and the length L. To extract attenuation factor β related to pipe material, the slope is normalized by dividing it by the pipe segment length L.

In further embodiments, the attenuation factor β may be determined from a lower resolution of spectral power ratio values in the selected frequency range. For example, spectral power ratio values may be computed for distinct octave bands of the spectrum, with the values computed from the acoustic powers of the signals at or averaged around the center frequency of each octave band. A line may then be fitted to the spectral power ratios by octave band, with the slope of the line representing the attenuation factor β (after normalization to the length L). Averaging the acoustic power density in octave bands results in lower transfer function regression. Similarly, two distinct frequency values within the selected frequency range may be selected and a line fitted to the spectral power ratios between the two frequencies, with the attenuation factor β extracted from the fitted line.

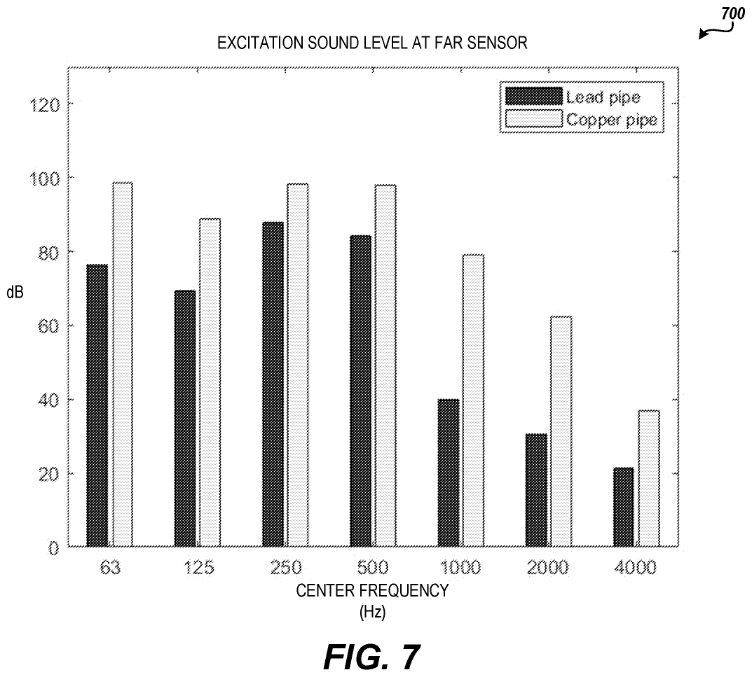

FIG. 7 shows an octave band representation of the spectrum for recorded signals measured at the far sensor for both a lead service line 102 and a copper pipe. The octave band representation was chosen to reduce noise. The excitation and pipe length L were similar for the lead and copper experiments. As can be seen in FIG. 7, the maximum sensitivity occurs between 1000 to 3000 Hz. Thus, measuring the ratio of acoustic power in this range can identify the pipe material. The measurements should be normalized to the pipe length L as longer pipes attenuate the sound more.

The routine 200 then proceeds from step 226 to step 228, where the estimated attenuation factor β of the pipe 102 under test is related to a material of the pipe. The (length-normalized) attenuation factor β of a particular water-filled pipe may be determined by:

$$β = \frac{1}{2} \frac{η \frac{KD}{Eh}}{\sqrt{1 + \frac{KD}{Eh}}}$$

where K is the bulk modulus of water, E is the Young's modulus of the pipe material, D is the internal diameter of the pipe, h is the pipe wall thickness, and n describes acoustic damping in the pipe wall based on the pipe's material properties, which is a significant variable influencing acoustic attenuation in pipes. While these models do not take into account attenuation from energy radiation into the surrounding media of the pipe 102 (e.g., soil), those skilled in the art will understand that investigations into this phenomenon demonstrate that that the attenuation due to loss in the surrounding media is negligible compared to the loss due to the material properties of the pipe.

According to some embodiments, knowing the Young's modulus E of lead and the η value for lead-based pipe materials, a list of expected attenuation factors β may be computed for fluid-filled, lead-based service lines 102 of standard diameters D and wall thicknesses h, and a threshold attenuation factor β_{ref} predetermined that is indicative of service lines consisting primarily of lead material. In other embodiments, the threshold attenuation factor β_{ref} to be utilized to differentiate lead service lines 102 may be determined through experimentation using variations of the method(s) described herein with service lines of standard sizes and known materials. According to some embodiments, the predetermined threshold attenuation factor β_{ref} may be stored in the memory 134 of the pipe assessment system 130.

If, at step 228, the pipe assessment system 130 determines that the measured attenuation factor β for the pipe 102 computed in steps 222-226 is greater than the threshold attenuation factor β_{ref}, then the routine 200 proceeds to step 220, where the pipe assessment system 130 determines that the dominant material of the pipe 102 is likely lead. While the routine 200 is shown with the pipe assessment system 130 measuring both a speed of sound c (in steps 214-218) and a length-normalized attenuation factor β (in steps 222-226) in the pipe 102 under test from the signal data, it will be appreciated that in some embodiments the pipe assessment system 130 may calculate only one or the other measurement depending on the needs of the application. As discussed above, the pipe assessment system 130 may utilize both the attenuation and the speed of sound measurements to determine the pipe material. However, a greater emphasis may be placed on the determination of the pipe material from the measurement of the attenuation as the attenuation measurement is subject to less error than the speed measurement. In further embodiments, the pipe assessment system 130 may utilize either the attenuation measurement or the speed of sound measurement to determine the pipe material. From step 220, the routine 200 ends.

While the embodiments described above and shown in the figures describe and depict a discrete acoustical wave 120 propagating through the service line 102, this is done for clarity of illustration and explanation, and it will be appreciated that the techniques and methodologies described herein are generally applicable to signals recorded from any sound propagating through the service line comprising one or more acoustical impulses, vibrations, or pressure waves generated in the fluid path of the pipe by the excitation, including an acoustical wave generated from a continuous broad-band sound source. Further, while the figures and associated descriptions show a service line 102 being tested, it will be appreciated that the methods described herein could be utilized to determine the material of any pipe segment bracketed by two acoustic sensors 112.

Based on the foregoing, it will be appreciated that technologies for determining the material of a pipe in a non-invasive manner are presented herein. The above-described embodiments are merely possible examples of implementations set forth for a clear understanding of the principles of the present disclosure. Many variations and modifications may be made to the above-described embodiments without departing substantially from the spirit and principles of the present disclosure. All such modifications and variations are intended to be included within the scope of the present disclosure, and all possible claims to individual aspects or combinations and sub-combinations of elements or steps are intended to be supported by the present disclosure.

The logical steps, functions or operations described herein as part of a routine, method or process may be implemented (1) as a sequence of processor-implemented acts, software modules or portions of code running on a controller or computing system and/or (2) as interconnected machine logic circuits or circuit modules within the controller or other computing system. The implementation is a matter of choice dependent on the performance and other requirements of the system. Alternate implementations are included in which steps, operations or functions may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

What is claimed is:

1. A method comprising steps of:
placing a first acoustic sensor near a first end of a segment of a pipe under test and a second acoustic sensor near an opposite end of the pipe segment, the first and second acoustic sensors in acoustical communication with the pipe under test;
generating at least one acoustical wave in the pipe under test using an excitation source at an out-of-bracket excitation location while recording, by a pipe assessment system, signal data from the first and second acoustic sensors, where signal data signal represents vibrations measured at the first and second acoustic sensors caused by the at least one acoustical wave propagating through the pipe under test;
computing, by the pipe assessment system, one or more of a speed of sound in the pipe segment and an attenuation factor for the pipe segment from the signal data; and
determining, by the pipe assessment system, a material of the pipe under test based upon one or more of the computed speed of sound in the pipe segment and a relationship between the speed of sound in pipe and a material of the pipe and the computed attenuation factor for the pipe segment and a relationship between the attenuation factor of a pipe and the material of the pipe.

2. The method of claim 1, wherein measuring the speed of sound in the pipe segment comprises:
estimating, by the pipe assessment system, a time delay between a time of arrival of the at least one acoustical wave at the first acoustic sensor and a time of arrival of the at least one acoustical wave at the second acoustic sensor; and
computing, by the pipe assessment system, the speed of sound in the pipe segment from the estimated time delay and a distance along the pipe segment between the first acoustic sensor and the second acoustic sensor.

3. The method of claim 2, wherein estimating the time delay comprises performing, by the pipe assessment system, a cross-correlation between the signal data from the first and second acoustic sensors.

4. The method of claim 1, wherein measuring the attenuation factor for the pipe segment comprises:
computing a power spectral density for the first acoustic sensor and a power spectral density for the second acoustic sensor from the corresponding signal data;
computing a transfer function as the ratio between the power spectral densities for the first acoustic sensor and the second acoustic sensor; and
determining the attenuation factor from the computed transfer function and a length of the pipe segment.

5. The method of claim 4, wherein determining the attenuation factor from the computed transfer function and the length of the pipe segment comprises:
fitting, by the pipe assessment system, the transfer function to a line over a selected frequency range using linear regression;
determining a slope of the line; and
dividing the slope by the length of the pipe segment.

6. The method of claim 1, wherein the relationship between the speed of sound in a pipe and the material of the pipe comprises a range of speeds of sound expected for service lines consisting primarily of lead, and wherein determining the material of the pipe under test comprises determining whether the measured speed of sound in the pipe segment falls in the expected range of speeds of sound in service lines consisting primarily of lead.

7. The method of claim 6, wherein the range of speeds of sound expected for service lines consisting primarily of lead is determined through experimentation comprising performing the placing, generating, and measuring steps of the method on a plurality of service lines of known properties and materials.

8. The method of claim 1, wherein the relationship between the attenuation factor of a pipe and the material of the pipe comprises a threshold attenuation factor identifying service lines consisting primarily of lead, and wherein determining the material of the pipe under test comprises determining whether the measured attenuation factor for the pipe segment exceeds the threshold attenuation factor identifying service lines consisting primarily of lead.

9. The method of claim 8, wherein the threshold attenuation factor identifying service lines consisting primarily of lead is determined through experimentation comprising performing the placing, generating, and measuring steps of the method on a plurality of service lines of known properties and materials.

10. The method of claim 1, wherein the first acoustic sensor is attached to an external stop tap at a connection of a service line to a water main.

11. The method of claim 10, wherein generating the at least one acoustical wave in the pipe segment using an excitation source at an out-of-bracket excitation location comprises striking an appurtenance of the water main with a hammer.

12. The method of claim 1, wherein the second acoustic sensor is attached to one or more of an internal stop tap, a meter, and an exposed wall of a service line at a termination of the service line at a building served by the service line.

13. A water distribution system comprising:
a service line connecting a water main of the water distribution system to a building served by the water distribution system;
a first acoustic sensor and a second acoustic sensor in acoustical communication with the service line and configured to sense acoustical waves propagating through the service line and produce signal data representing the sensed acoustical waves, the first and second acoustic sensors bracketing a segment of the service line; and
an acoustic analysis module executing on a pipe assessment system communicatively coupled to the first and second acoustic sensors, the acoustic analysis module configured to:
record signal data from the first and second acoustic sensors during generation of an acoustical wave in the service line at an out-of-bracket excitation location,
estimate an attenuation of the acoustical wave as it propagated along the service line from the first acoustic sensor to the second acoustic sensor,
compute an attenuation factor from the estimated attenuation, and
determine whether the service line consists of lead based upon the attenuation factor for the service line and a relationship between attenuation factors of various service lines and the materials of the various service lines.

14. The water distribution system of claim 13, wherein computing the attenuation of the acoustical wave in the service line comprises:
computing power spectral densities for the first acoustic sensor and the second acoustic sensor from the corresponding signal data;
computing a transfer function between the power spectral densities for the first acoustic sensor and the second acoustic sensor over a selected frequency range; and
computing the attenuation factor from the computed transfer function and a length of the pipe segment.

15. The water distribution system of claim 13, wherein the relationship between the attenuation factors of the various service lines and the materials of the various service lines comprises a threshold attenuation factor identifying service lines consisting primarily of lead, and wherein determining whether the service line consists of lead comprises determining whether the attenuation factor for the service line exceeds the threshold attenuation factor.

16. The water distribution system of claim 13, wherein the acoustic analysis module is further configured to:
estimate a time delay between a time of arrival of the acoustical wave at the first acoustic sensor and a time of arrival of the acoustical wave at the second acoustic sensor;
compute a speed of sound in the service line from the estimated time delay and a length of the segment of the service line between the first acoustic sensor and the second acoustic sensor; and
determine whether the service line consists of lead based further upon the speed of sound in the service line and a relationship between speeds of sound in the various service lines and the materials of the various service lines.

17. The water distribution system of claim 16, wherein estimating the time delay between the time of arrival of the acoustical wave at the first and second acoustic sensors comprises performing a cross-correlation between the signal data from the first and second acoustic sensors.

18. The water distribution system of claim 16, wherein the relationship between the speeds of sound in the various service lines and the materials of the various service lines comprises a range of speeds of sound expected for service lines consisting primarily of lead, and wherein determining whether the service line consists of lead further comprises determining whether the computed speed of sound in the service line falls in the expected range of speeds of sound.

19. A non-transitory computer-readable medium containing processor-executable instructions that, when executed by a processor of a pipe assessment system, cause the processor to:
record signal data from a first acoustic sensor and a second acoustic sensor during generation of an acoustical wave in a pipe at an out-of-bracket excitation location, the first and second acoustic sensors in acoustical communication with the pipe and bracketing a segment of the pipe, the signal data representing measurements of vibrations at the first and second acoustic sensors caused by the at least one acoustical wave propagating through the pipe;
compute one or more of a speed of sound in the pipe and an attenuation factor for the pipe segment based on the recorded signal data; and
determine whether the pipe consists of lead based upon one or more of the speed of sound in the pipe segment and a relationship between speeds of sound in pipes and materials of the pipes and the attenuation factor for the pipe segment and a relationship between attenuation factors of the pipes and the material of the pipes.

20. The non-transitory computer-readable medium of claim 19, wherein the pipe comprises a service line connecting a building to a water main of a water distribution system.
